(19) United States
(12) Patent Application Publication
(10) Pub. No.: US 2011/0116902 A1
(43) Pub. Date: May 19, 2011

(54) CABLE REEL TRAILER

(75) Inventors: Noel C. Smith, Philadelphia, PA (US); John Zitkus, Pottstown, PA (US); John Ferguson, Southampton, PA (US); Dean Wenger, Lititz, PA (US); Lloyd Glick, Bird-in-Hand, PA (US); Brian F. Forde, New York, NY (US)

(73) Assignee: REELSTRONG, LLC, Philadelphia, PA (US)

(21) Appl. No.: 12/946,181

(22) Filed: Nov. 15, 2010

Related U.S. Application Data
(63) Continuation of application No. 12/366,862, filed on Feb. 6, 2009, now abandoned.

(51) Int. Cl. B60P 3/035; B65H 49/26; B65H 49/32; B65H 59/00

(52) U.S. Cl. 414/546; 242/598.5; 242/416; 414/812

(57) ABSTRACT

The present invention pertains to a trailer for lifting and transporting cable reels. The trailer has a base, a pair of substantially perpendicular cantilevers, and a latch assembly. The cantilevers lift a cable reel off of the ground, and the latch assembly transfers at least a portion of the weight of the reel from the cantilevers to the base. The base is mounted on wheels and can be pulled or pushed by a vehicle connected to the base.

This application claims priority from, and the benefit of U.S. provisional patent application Ser. No. 61/026,615, filed Feb. 6, 2008, entitled Cable Reel Trailer and U.S. provisional patent application Ser. No. 61/105,524, filed Oct. 15, 2008, entitled Cable Reel Trailer, and is a Continuation application of copending U.S. application Ser. No. 12/366,862, entitled Cable Reel Trailer, filed Feb. 6, 2009, all of which are incorporated herein by reference.

### FIELD OF THE INVENTION

The present invention relates generally to the field of lifting and transporting equipment, and more particularly to a trailer for cable reels.

### BACKGROUND

Electrical power, fluid power, fiber optic, and telephone systems require long extensions of cables, fibers, wires, hoses, or other elongated flexible elements (hereinafter collectively referred to as “cables”) to transmit power or information between a supply and a consumer. These systems also require large quantities of cables to be produced, stored, and transported. Cables that are not properly stored and transported are subject to damage or destruction.

Cables are stored and transported by being wrapped around large reels, also called spools. When not in use, reels can be rested on their edges on the ground or floor. In order to wind or unwind cable on a reel, the reel desirably must be lifted off the ground. Reels typically have a central opening through which an spindle can pass. Rigid spindles are inserted by workers such that the ends of the spindle protrude beyond the openings on each side of the reel. The spindle and reel are lifted by engaging the ends of the spindle with a lifting mechanism, or by applying manual force to the ends of the spindle. The spindle must be lifted enough so that the reel no longer touches the ground and is free to rotate around the spindle. The reel rotates around the spindle as the cable is pulled onto or off of the reel. Cable is usually applied to reels at one site, and then filled reels are transported to another site where the cable is pulled off for use.

Cable-filled reels are heavy and become unstable when lifted off the ground. The task of lifting reels to transport them, or to wind and unwind cable on them, is dangerous and labor-intensive. Devices for lifting reels are known in the art, and include spring or hydraulically powered machines. Such machines are often heavy or encounter problems with stability. Examples of known devices appear in U.S. Pat. Nos. 7,000,900 and 4,473,197. Known devices for transporting reels include flat bed trucks with some means of securing the reel to the bed. Flat bed trucks present the problem of inadvertent disengagement of the reel from the bed and damage to the reel. Flatbed trucks are bulky, and cable cannot be accessed once a reel is loaded onto a bed. Loading the reel onto the bed requires hoists or cranes for lifting and positioning the reel on the bed. Such methods are prone to accidents and create a risk of damage to reels and injury to workers.

Self-loading reel lifts and trailers known in the art do not completely overcome the problems associated with lifting and transporting reels on truck beds. Known self-loading devices have moving parts similar to cranes and beds on which the reel rests during transport. An example of a known self-loading cable reel trailer appears in U.S. Pat. No. 4,762,291. A shortcoming associated with known self-loading devices is complexity of design. Animated parts and complicated movement causes wear and tear of the devices. Large and numerous parts create excess mass. Thus, known devices encounter problems of undesirable wear and undesirable weight.

Known devices require pins to secure reels to spindles. After the spindle is inserted through the opening in the reel, pins must be inserted across or over the spindle to prevent the reel from slipping off of the trailer. These pins are sometimes forgotten, misplaced, or improperly inserted, creating the risk that a reel and/or a spindle will fall from trailer. This risk poses a danger of injury or death to nearby people. Such devices encounter problems of dangerous accidents.

A need exists for a device that safely and efficiently lifts and secures cable reels for winding, unwinding, and transporting. A need also exists for a simple and durable machine that lifts and secures reels with minimal manual labor or other human assistance. Furthermore, a need exists for a device that operates safely, without the need for pins to secure the reels to the trailer.

### SUMMARY OF THE INVENTION

The invention relates to a cable reel trailer. The trailer includes a base, a pair of substantially parallel cantilevers pivotally connected to the base, and a latch assembly connected to the base.

The base includes a frame comprising two substantially parallel beams connected by at least one substantially perpendicular crossbeam. The base also includes two towers extending outwardly from the frame. The base includes two wheels. The wheels are connected to the frame or to the towers. The base also includes one or more tow beams connected to the frame, and a coupling connected to at least one of the tow beams.

The cantilevers pivot with respect to the base, thereby changing the angle between the cantilevers and the frame. The pivoting motion of the cantilevers is powered by a pair of hydraulic cylinders. The latch assembly engages and disengages the pair of cantilevers to secure them in, or release them from, a fixed position with respect to the base. The cantilevers can be connected by one or more crosspieces. The cantilevers can also include a pair of deflection gussets.

The latch assembly includes two pegs connected to one of each of the two towers. The latch assembly also includes two latches, wherein each latch is rotatably connected to one of each of the two pegs. The latch assembly also includes two cords. One end of each cord is connected to one of each of the two latches. Two guides are connected to the frame. One of each cord bends around one of each of the two guides. A handle is pivotally connected to the base, and also to the other ends of the two cords.

The cantilevers engage an spindle that passes through a reel. The cantilevers pivot with respect to the base, thereby lifting the reel by the spindle. The latch assembly secures the cantilevers in a fixed position with respect to the base, and also transfers at least a portion of the weight of the reel from the cantilevers to the base. The trailer can be transported by a vehicle coupled to the coupling. An overspin brake can be attached to at least one of the towers.

### BRIEF DESCRIPTION OF THE DRAWINGS

FIG. 1 is a is a perspective view of a trailer in one embodiment, shown loaded with a reel assembly.

FIG. 2 is a perspective view of the trailer of FIG. 1 without a reel assembly, shown in a loading position.

FIG. 3 is a cut away perspective view of a portion of a tower of the trailer of FIG. 1 showing a portion of a latch assembly.

FIG. 4 is a cut away perspective view of a portion of a tower of the trailer of FIG. 1 showing a guide portion of a latch assembly.

FIG. 5 is a perspective view of a handle portion of a latch assembly of the trailer of FIG. 1.

FIG. 6 is a side view of a portion of a tower of the trailer of FIG. 1, shown in a lowered position.

FIG. 7 is a side view of a portion of a tower of the trailer of FIG. 1, shown in a raised position.

FIG. 8 is a side view of a trailer in a different embodiment than FIG. 1, shown loaded with a reel assembly in a fully raised position.

FIG. 9 is a perspective view of the trailer of FIG. 8, shown loaded with a reel assembly, in a partially raised position.

FIG. 10 is a perspective view of the trailer of FIG. 8, shown loaded with an spindle, in a lowered position.

FIG. 11 is a perspective view of the trailer of FIG. 8, shown unloaded and from a different angle than FIG. 10.

FIG. 12 is a cut away perspective view of a portion of the trailer of FIG. 8, shown loaded with an spindle, in a raised, unlatched position.

FIG. 13 is a cut away perspective view of a portion of the trailer of FIG. 8, shown loaded with an spindle, in a raised, unlatched position, and from a different angle than FIG. 12.

FIG. 14 is a cut away perspective view of a portion of the trailer of FIG. 8, shown loaded with an spindle, in a fully raised, latched position.

FIG. 15 is a perspective view of a portion of the trailer of FIG. 8, loaded with a reel assembly, and showing an overspin brake attached to a tower.

FIG. 16 is a cut away perspective view of a portion of the trailer of FIG. 8, loaded with a spindle, in a raised position, and showing a latch assembly.

FIG. 17 is a side perspective view of a portion of a tower of the trailer of FIG. 1, showing an alternative latch assembly formed in accordance with the present invention.

### DETAILED DESCRIPTION

The present invention pertains to an apparatus for lifting and transporting cable reels. The description is intended to be read in connection with the accompanying drawings. The drawing figures are not necessarily to scale and certain features of the invention can be shown exaggerated in scale or in somewhat schematic form in the interest of clarity and conciseness. As used in this description, the term “proximal” refers to the end, portion, or side of a structure that is generally nearer to or generally facing the point of contact between the trailer and the reel. Likewise, the term “distal” refers to the end, portion, or side of a structure that is generally farther from or facing away from the point of contact between the trailer and the reel, as compared with that structure's proximal end, portion, or side. The terms “attached” and “connected” refer to direct attachment between structures such as by welding, riveting, or bolting, indirect attachment, such as through intervening structures, or structures that are integral with one another. Relative terms such as “horizontal,” “vertical,” “up,” “down,” “top,” and “bottom” refer to the orientation of the invention as then described or shown in the drawing figure under discussion. These relative terms do not necessarily require a particular orientation.

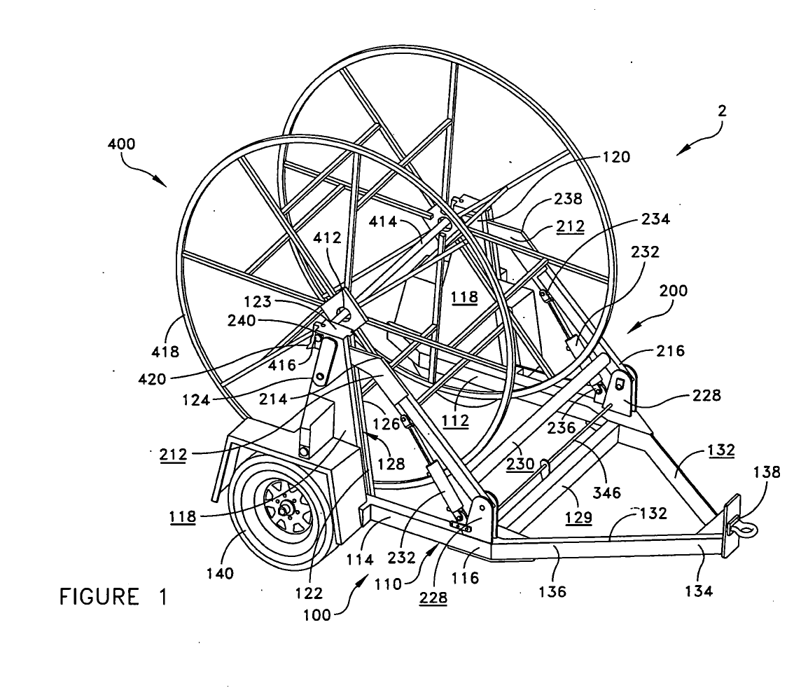

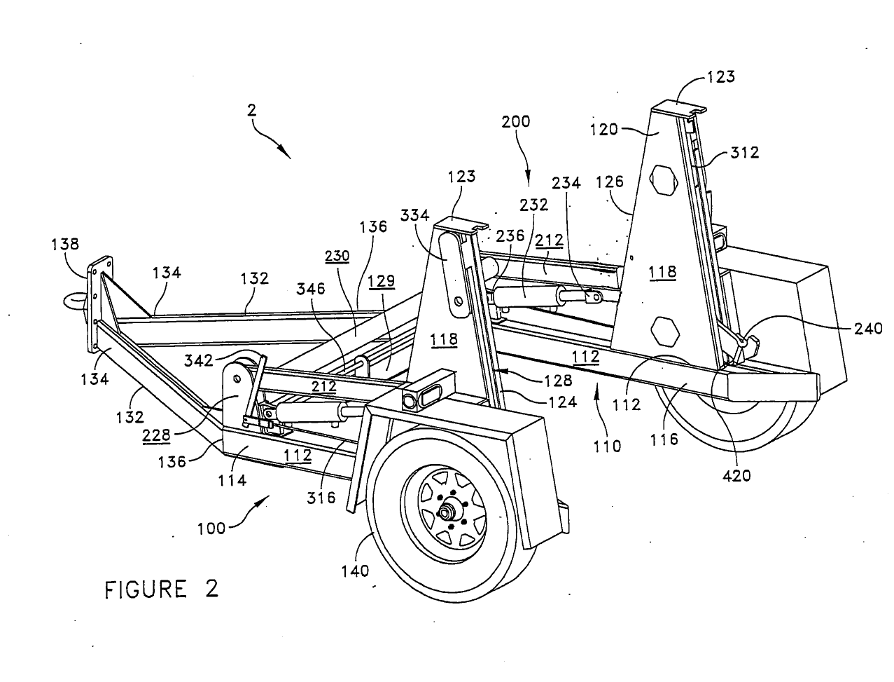

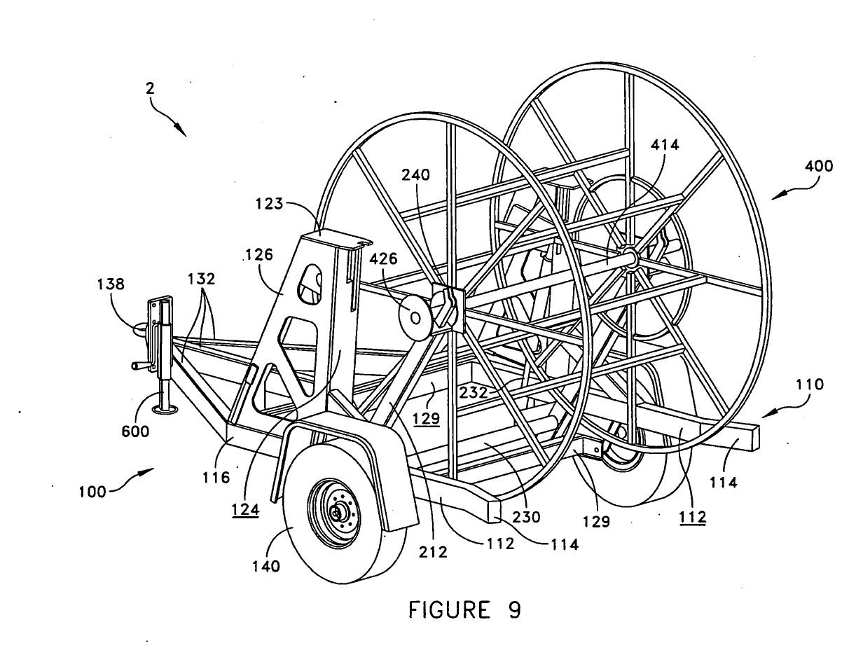

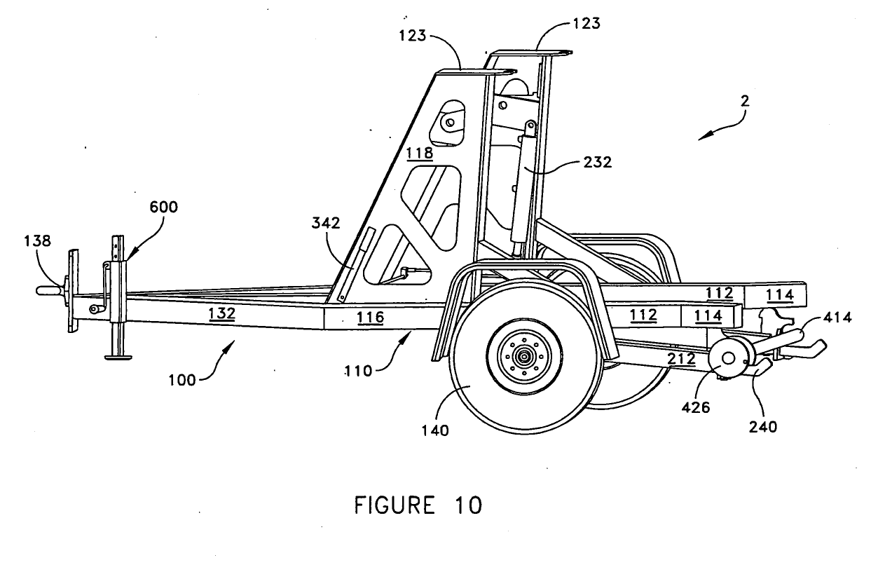

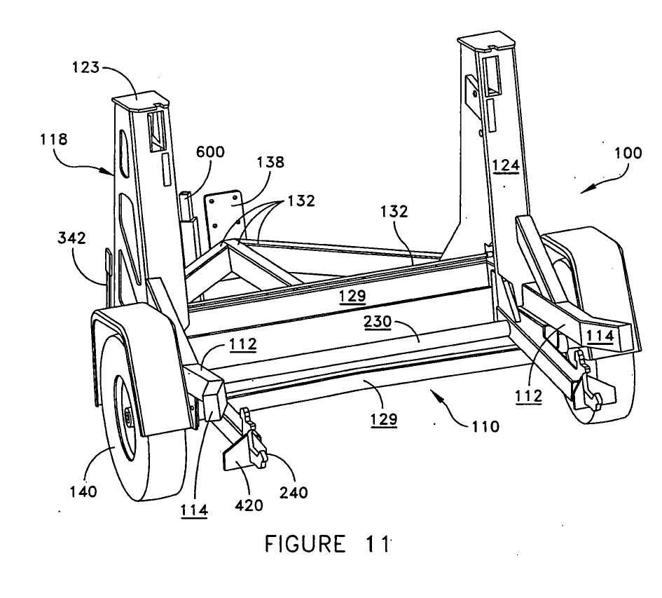

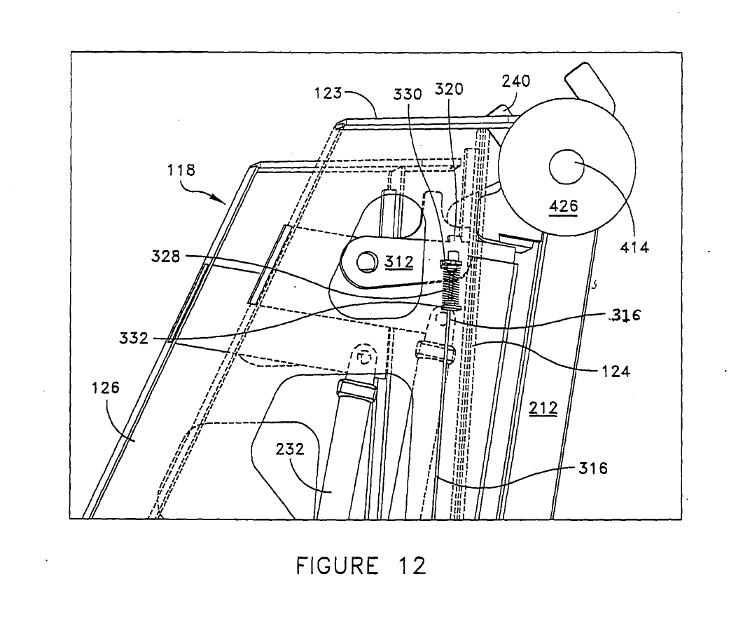

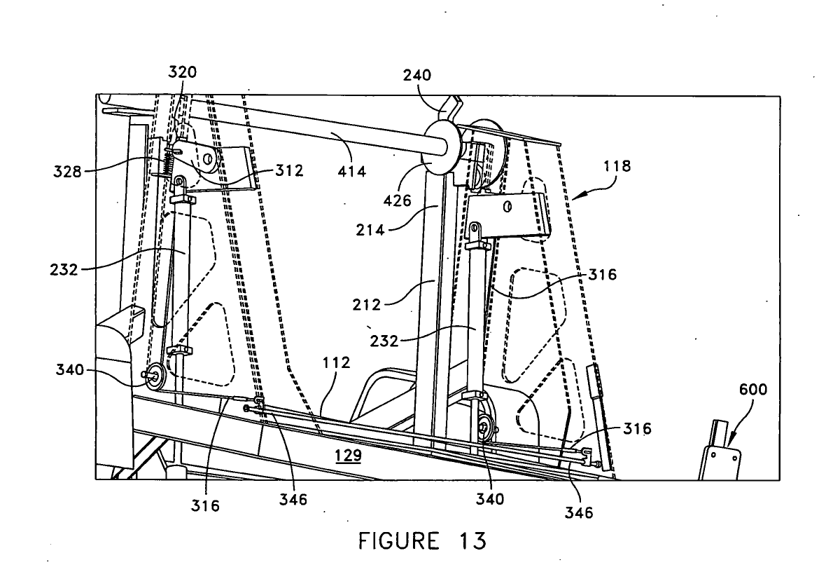

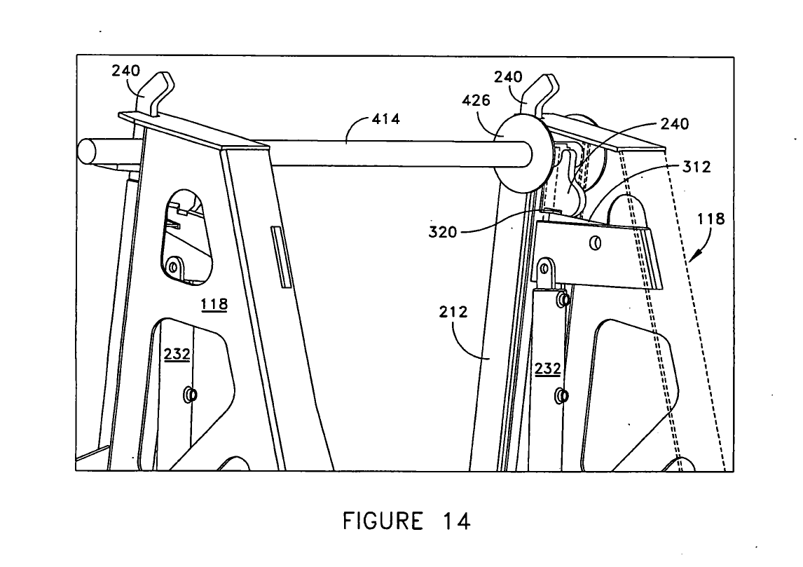

Referring to FIGS. 1-16, in one embodiment, a trailer 2 includes a base 100, a cantilever assembly 200, and a latch assembly 300.

The base 100 has a generally horizontal frame 110, including two horizontal beams 112. The beams 112 are elongate structures and can be rectangular, rod-shaped, hollow, or solid. The beams 112 can be constructed from aluminum, steel, fiberglass, plastic, or any material that is rigid enough to hold its shape, and strong enough to support a portion of the weight of a loaded cable reel. The two beams 112 are generally parallel to each other, and form part of the frame of the base. Each beam 112 has a proximal 114 and a distal 116 end.

Each of the beams 112 is attached to one of two towers 118, which extend outwardly from the frame 110. The towers 118 have top 120 and bottom 122 portions. The towers are elongate structures that can be rectangular, trapezoidal, and/or generally flat. The towers 118 can be constructed from aluminum, steel, fiberglass, plastic, or any material that is rigid enough to hold its shape, and strong enough to support the weight of a loaded cable reel. The towers 118 can comprise one or more plates, which can be solid or can have a lattice structure. The bottom portions 122 of the towers 118 are attached to the beams 112. The top portions 120 of the towers 118 have caps 123. Each tower 118 extends substantially perpendicularly from the beam 112 to which it is attached. Each tower 118 has a proximal 124 and distal 126 side. In one embodiment, each tower 118 is formed from two flat plates defining a space 128 therebetween. The space 128 extends from the proximal side 124 to the distal side 126 of each tower 118.

The beams 112 are attached to opposite ends of one or more crossbeams 129. The crossbeams 129 are elongate structures similar to the beams 112. The crossbeams 129 can be the same size, shape, and material as each other, and/or the beams 112, or they can differ. The crossbeams can be constructed from aluminum, steel, fiberglass, plastic, or any material that is rigid enough to hold its shape, and strong enough to support a portion of the weight of a loaded cable reel. The crossbeams 129 extend generally perpendicular to the beams 112, and form a portion of the horizontal frame 110.

The base 100 includes one or more tow beams 132 having distal 134 and proximal 136 ends. The tow beams are elongate structures similar to the beams 112. The tow beams can be a similar size, shape, and material as the beams 112, or it can differ. The tow beam(s) 132 can be constructed from aluminum, steel, fiberglass, plastic, or any material that is rigid enough to hold its shape, and strong enough to tow the weight of the trailer and a loaded cable reel. Each of the proximal ends 136 of the one or more tow beams 132 is attached to one of each of the beams 112 or crossbeam(s) 129. The distal end 134 of each of the one or more tow beams 132 is attached to a coupling 138. The coupling 138 is a conventional coupling used for joining trailers to vehicles for transport. The base 100 also has two or more wheels 140 attached to the beams 112 and/or the towers 118. The wheels 140 can have tires and can be any kind of wheel known in the art that is appropriate for trailers, or transportation of heavy equipment, on- or off-road.

The cantilever assembly 200 includes a pair of cantilevers 212 extending from the base 100. Each cantilever 212 has a proximal end 214 and a distal end 216. The cantilevers 212 are pivotally connected to the base 100 at or near the distal ends 216. The cantilevers 212 can be pivotally connected directly to the frame 110 or can be connected to pivots 228, that are in turn attached to the frame 110. The cantilevers 212 pivot with respect to the base 100, raising and lowering the proximal ends 214 with respect to the frame 110. In one embodiment, the cantilevers 212 are pivotally attached to the frame 110.

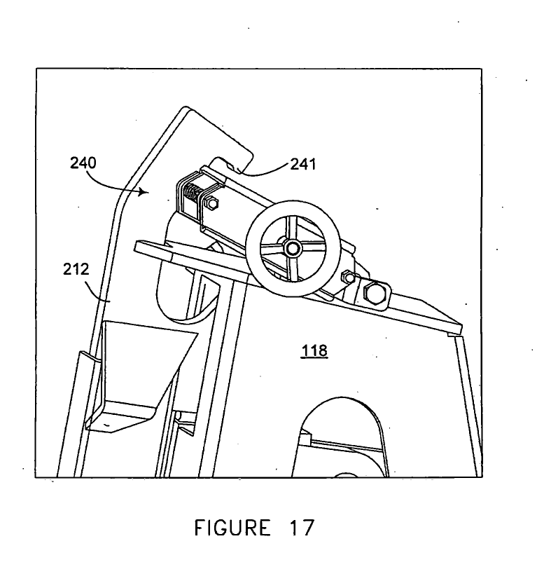

The proximal end 214 of each cantilever 212 forms a claw 240. The claw 240 can have many shapes including, for example, a slight curve, a hook, a square or rounded U shape, or a square or rounded lobster-claw shape. The claw 240 can also include one or more additional projections, such as a hook or overhang 241 extending outwardly and distally from the proximal end 214 of the cantilever 212 (FIG. 17). Such projections can engage other parts of the trailer.

The cantilevers 212 are attached to opposite ends of one or more crosspieces 230. The crosspieces 230 are substantially perpendicular to the cantilevers 212. The cantilever assembly 200 also includes a power source for raising and lowering the cantilevers 212. In one embodiment, the power source includes two hydraulically powered cylinders 232 having proximal 234 and distal 236 ends. In one embodiment, the distal end 236 of each cylinder 232 is pivotally attached to one of each of the beams 112, between the cantilever 212 and tower 118 attached to that beam 112. The proximal end 234 of each cylinder 232 is attached to one of each of the cantilevers 112, between the proximal 114 and distal 116 ends of the cantilever. In this embodiment, each cantilever 112 can be formed from a single elongate structure, or by connecting more than one elongate structure. Each cantilever 112 can be straight, or can bend to define an angle 238.

The components of the cantilever assembly 200 can be constructed from aluminum, steel, fiberglass, plastic, or any material that is rigid enough to hold its shape, and strong enough to support a portion of the weight of a loaded cable reel.

In embodiments where the towers 118 are formed from two plates defining a space 128 therebetween, each cantilever 212 extends through the space 128 defined by one of each of the towers 118, such that the distal end 216 of the cantilever protrudes from the distal side 126 of the tower, and the proximal end 214 of the cantilever 212 protrudes from the proximal side 124 of the tower 118.

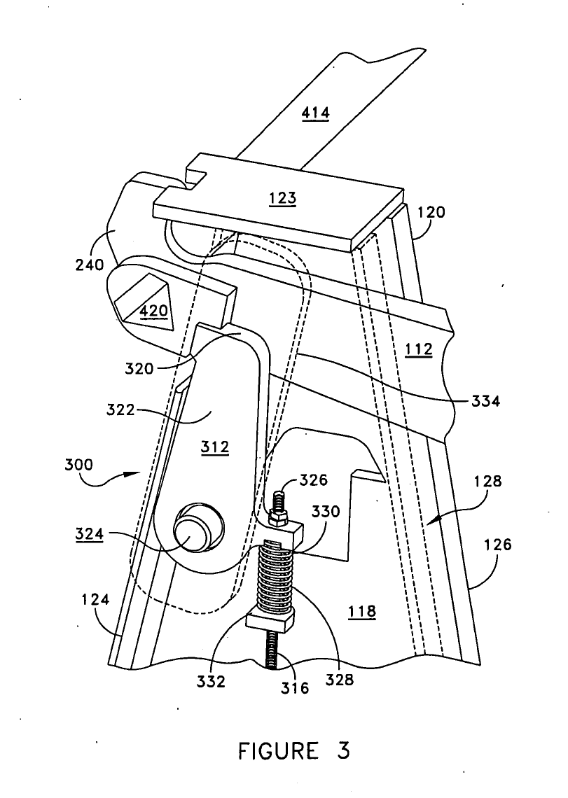

FIGS. 3, 4, and 5 show different parts of one embodiment of a latch assembly 300. In the embodiment shown, the latch assembly 300 includes two latches 312, two cords 316, and two guides 340. Referring to FIG. 3, each latch 312 has a catch 320 and a body 322. The body 322 of each latch 312 is rotatably attached to the one of each of the towers 118 by a peg 324. The body 322 of each latch 312 is also attached to the proximal end 326 of one of the two cords 316. Each cord 316 passes through a spring 328. The spring 328 has a proximal end 330 and a distal end 332. The proximal end 330 of the spring 328 resiliently engages the latch 312. The distal end 332 of the spring 328 is attached to the tower 118. In one embodiment, the latch assembly 300 also includes two plates 334, one of which is shown as an outline in FIG. 3. The plates 334 are attached to one of the each of the two towers 118 by the peg 324.

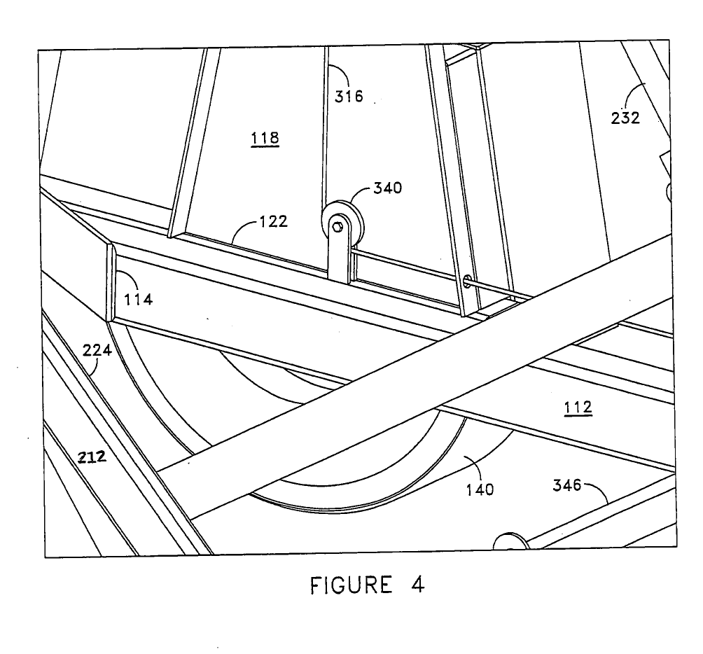

Referring to FIG. 4, each cord 316 extends from the latch 312, to a guide 340. The guide 340 is attached to the beam 112 within the space 128 defined by the tower 118. The cord 316 runs from the spring 328, down the space 128 defined by the tower 118, and bends around the guide 340.

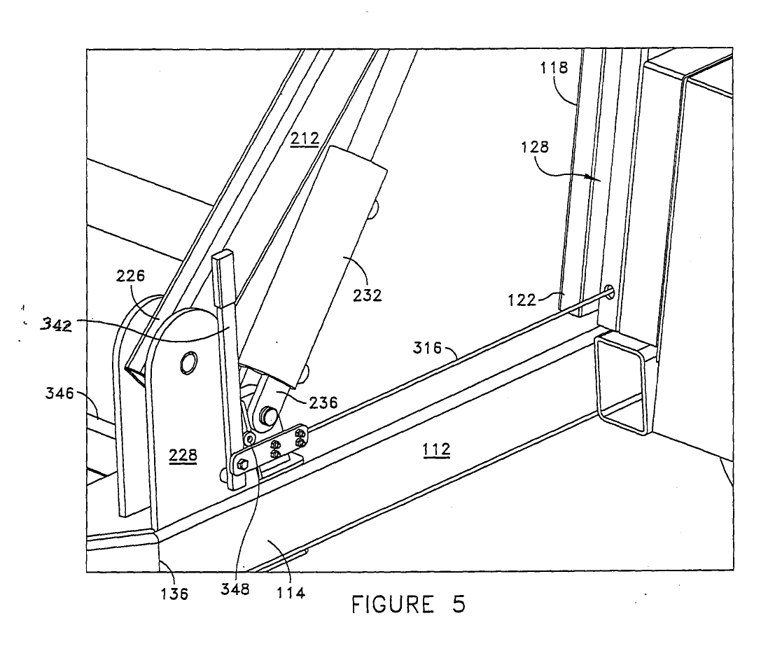

Referring to FIG. 5, a handle 342 mounted on the base 100. In one embodiment, the handle is mounted on one of the beams 112. The handle 342 is an elongated lever that is pivotally attached to the base 100. The handle 342 is attached to a rod 346, outside of the tower 118. The rod 346 runs parallel to the crosspiece 129 along the width of the frame 110. The pivoting motion of the handle 342 turns the rod 346 so as to advantageously, simultaneously engage cord 316. Each cord 316 runs from each guide 340 to opposite ends of the rod 346. The cords 316 can be attached to the rod 346 by, for example, a clevis. The turning motion of the rod 346 simultaneously pulls both of the cords 316, which in turn advantageously, simultaneously pull the latches 312 and compress the spring 328. This arrangement allows both latches 312 to be controlled, in unison, by pivoting a single handle 342. In one embodiment, the handle 342 engages a stop 348 that is attached to the frame 110. The stop 348 limits the pivoting motion of the handle 342. In another embodiment, the latch assembly 300 does not include a handle 324, and the latches are instead electronically controlled by a remote action such as actuating a switch or button.

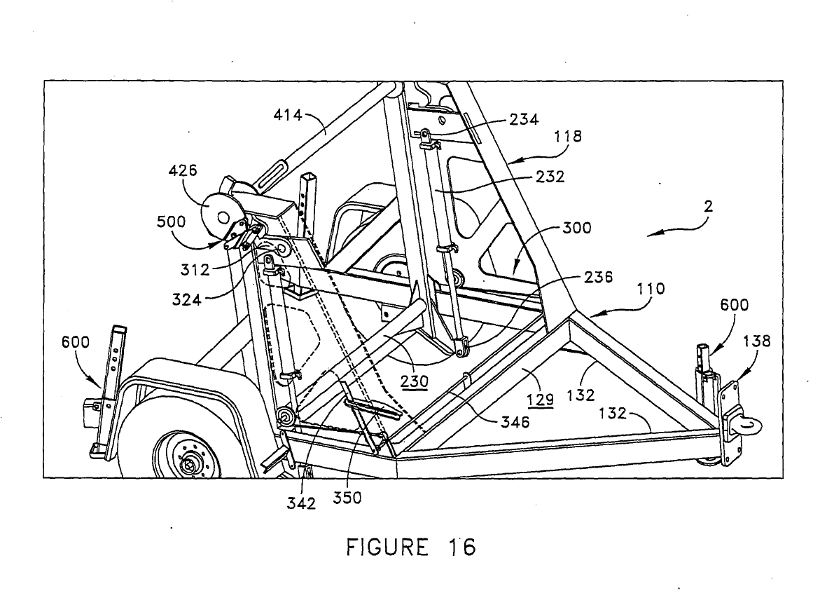

FIG. 16 shows the latch assembly 300 as a whole, in another embodiment of the trailer 2. In this embodiment, a slot 350 is attached to the tower 118 that is adjacent to the handle 342. The handle 342 extends through the slot 350, and moves along the slot 350 as it pivots. The slot 350 defines the outer limits of the pivoting motion of the handle. The latches 312 and the handle 342 can be constructed from aluminum, steel, fiberglass, plastic, or any material that is rigid enough to hold its shape, and strong enough to support a portion of the weight of a loaded cable reel. The spring 328 can be constructed from a rugged metal, or any material that is strong enough and resilient enough to keep the latch in place under the weight of a loaded cable reel assembly 400. The cords 316 can be constructed from braided wire, or any material that is flexible, durable, and strong enough to overcome the force of the spring 328.

FIG. 1 shows a reel assembly 400 having a central opening 412, through which an spindle 414 passes. The spindle 414 has end portions 416 that protrude beyond the openings 412 on either side of a reel 418. The claws 240 engage the end portions 416 of the spindle 414. In the embodiment shown in FIG. 17, overhang 241 advantageously acts to secure spindle 414 when trailer 2 is being moved up an inclined surface, e.g., a steep road or ramp.

Referring to FIGS. 1-5, to lift and transport reel assemblies 400, the trailer 2 shown begins in a loading position. In the loading position, the cylinder 232 is contracted, the cantilevers 212 are lowered, the handle 342 rests against the stop 348, and the latch assembly 300 is in a load-bearing position. A user positions the trailer 2 with respect to the reel assembly 400 to be lifted such that the cantilevers 212 are disposed on either side of the reel assembly 400 and the claws 240 are below the ends of the spindle 414. When the trailer 2 is in place, the user causes the cylinder 232 to extend, lifting the cantilever assembly 200 with respect to the frame 110. As the cantilevers 212 move through the space 128 towards the caps 123, the claws 240 engage the ends 416 of the spindle 414. The reel assembly 400 is lifted by the cantilever assembly 200 past the level of the latches 312. In one embodiment, the latches 312 are shaped such that the cantilevers 212 push past the latches 312 during the ascension of the cantilevers 212. The latches 312 then return to the load-bearing position by the action of the spring 328. The cylinder 232 then contracts again until the proximal ends 214 of the cantilevers 212 are resting on the catches 320 of the latches 312. The proximal ends 214 of the cantilevers 212 can have a protruding portion that engages the catches 320 of the latches, thereby allowing the latches 312 to secure the cantilevers 212 in a fixed position with respect to the base. The trailer 2 is now in the transport position. While in the transport position, the latches 312, pegs 324, and towers 118, and frame 110 together bear the weight of the reel assembly 400. The cylinders 232 can also bear a portion of the weight of the reel assembly 400. The caps 123 attached to the top portions 120 of the towers 118, prevent the spindle 414 from being displaced during transport. The trailer 2 and reel assembly 400 can be transported by connecting a vehicle to the coupling 138 and pushing or pulling the trailer 2 with the vehicle.

To unload the reel assembly 400 from the trailer 2 shown in FIGS. 1-5, the user raises the cantilever assembly 200 to release the weight of the reel assembly 400 from the latches 312. The user then lowers the latches 312 by pulling the handle 342 away from the stop 348. The arms 212 are then free to move through the space 128 defined by the towers 118. The cantilever assembly 200 lowers the reel assembly 400 until the reel assembly 400 is resting on the ground. The cantilever assembly 200 continues to lower until the claws 240 no longer make contact with the spindle 44, and there is clearance between the arms 212 and the spindle 414. The trailer 2 can then be moved away from the reel assembly 400.

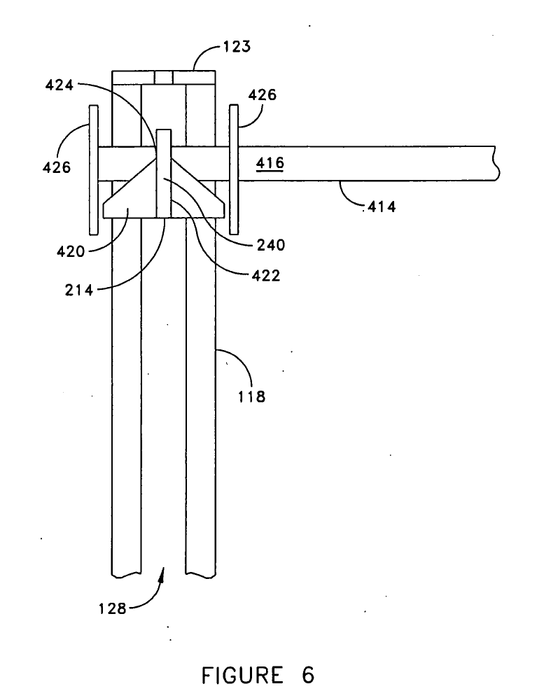

FIG. 6 shows a portion of a tower 118, spindle 414, and arm 212 of one embodiment in a lowered position. During loading, the arm 212 approaches the spindle 414, and one of the gussets 420 engages one of the retainers 426. As the arm 212 continues to rise, the retainer 426 will be deflected along the gusset 420, until the reel assembly 400 is substantially evenly balanced between the two claws 240.

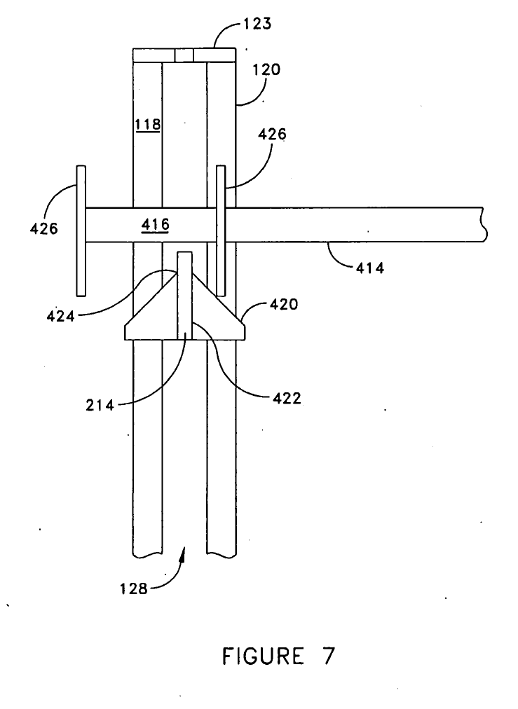

FIG. 7 shows a portion of a tower 118, spindle 414, and arm 212 in the transport position. The spindle 414 is held in the claws 240 and the retainers 426 are disposed on either side of the gussets 420. In this position, the cap 123 prevents the spindle 414 from becoming displaced during transport.

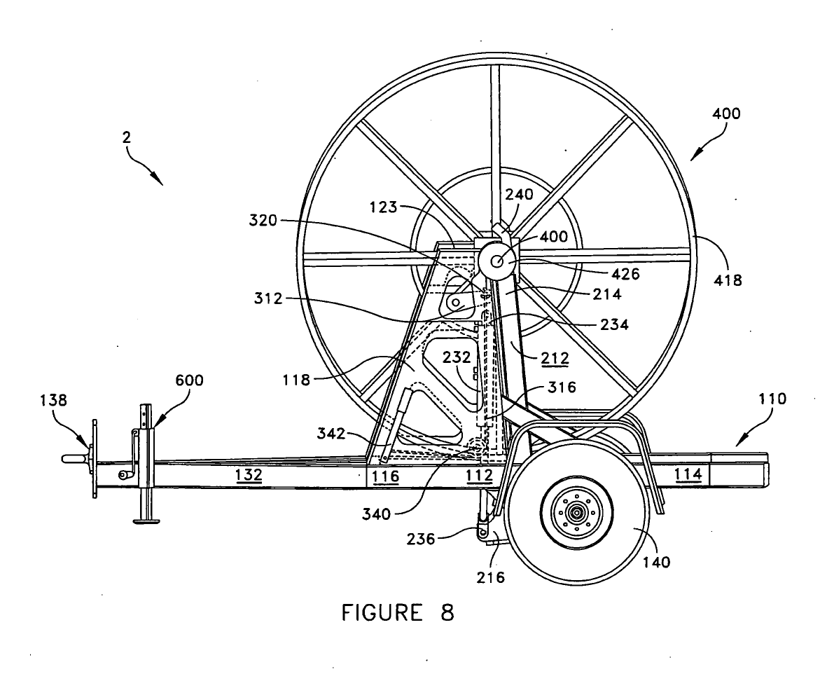

Referring to FIGS. 8-14, in another embodiment of the invention, the cantilevers 212 can be pivotally attached to the beams 112, such that the distal ends 216 of the cantilevers 212 extend beyond the points of connection between each cantilever 212 and beam 112. The distal ends 236 of each hydraulic cylinder 232 are pivotally attached to the distal ends 216 of one of each cantilever. The proximal ends 234 of each cylinder 232 are pivotally attached to the top portions 120 of one of each tower 118. The proximal ends 114 of the beams 112 can bow slightly away from each other, to allow for faster and easier loading of a reel assembly 400. The claws 240 are each shaped such that a protruding portion of each claw 240 has a shape that is complementary to the catch 320 of each latch 312. The catches 320 secure the position of the cantilevers 212 with respect to the base 100 by engaging the complementary shape of the claws 240.

The latch assembly 300, in the embodiments shown in FIGS. 8-14, can be configured to secure the cantilevers 212 in a fixed position with respect to the base 100 using mostly tension (rather than mostly compression, as shown in FIGS. 1-7). In this embodiment, the latch transfers at least a portion of the weight of a reel assembly 400 to the base, through the towers 118, which support the transferred weight mostly by tension (rather than mostly by compression, as shown in FIGS. 1-7). The remainder of the weight, if any, is transferred to the base 100 through the point of attachment between the cantilevers and the frame 110, or is supported by the hydraulic cylinders 232. In this embodiment, the latch is disposed generally horizontally when in the transport position (rather than mostly vertically, as in FIGS. 1-7). The cantilevers 212 are disposed generally vertically when in the transport position (as opposed to being disposed at an acute angle with respect to the frame 110, as in FIGS. 1-7).

Referring to FIGS. 8-14, to lift and transport reel assemblies 400, the trailer 2 shown begins in a loading position. In the loading position, the cylinder 232 is contracted, the cantilevers 212 are lowered, the handle 342 rests against the stop 348, and the latch assembly 300 is in a load-bearing position (although it is not currently bearing a load). A user positions the trailer 2 with respect to the reel assembly 400 to be lifted such that the cantilevers 212 are disposed on either side of the reel assembly 400 and the claws 240 are below the ends of the spindle 414. When the trailer 2 is in place, the user causes the cylinder 232 to extend, lowering the distal ends 216 of the cantilevers 212, and thereby raising the proximal ends 214 of the cantilevers 212 with respect to the frame 110. As the cantilevers 212 move towards the caps 123 of the towers 118, the claws 240 engage the ends 416 of the spindle 414. The reel assembly 400 is lifted by the cantilever assembly 200 past the catches 320 on the latches 312. The catches 320 are then returned to the load bearing position and engage the proximal ends 214 of the cantilevers 212. In one embodiment, the latches 312 are shaped such that the cantilevers 212 depress and push past the latches 312 as the cylinders 232 extend. The latches 312 then return to the load-bearing position by the action of the spring 328, and the catches 320 engage the proximal ends 214. The cylinders 232 can then be contracted again until the claws 240 or proximal ends 214 of the cantilevers 212 rest against the catches 320 of the latches. The trailer 2 is now in the transport position. While in the transport position, the latches 312, pegs 324, towers 118, cantilevers 212, and frame 110 together bear at least a portion of the weight of the reel assembly 400. The cylinders 232 can also bear a portion of the weight of the reel assembly 400. The caps 123 attached to the top portions 120 of the towers 118, prevent the spindle 414 from being displaced during transport. The trailer 2 and reel assembly 400 can be transported by connecting a vehicle to the coupling 138 and pushing or pulling the trailer 2 with the vehicle.

To unload the reel assembly 400 from the trailer 2 shown in FIGS. 8-14, the user extends the cylinders 232 enough to release the weight of the reel assembly 400 from the latches 312, if necessary. The user then lowers the latches 312 by pulling the handle 342 away from the stop 348 until the catches 230 disengage the proximal ends 214 of the cantilevers 212. The cantilevers 212 can then lower the reel assembly 400 until the reel assembly 400 is resting on the ground. The cantilevers 212 continue to lower until the claws 240 no longer make contact with the spindle 440, and there is clearance between the proximal ends 214 and the spindle 414. The trailer 2 can then be moved away from the reel assembly 400.

Referring to FIGS. 6 and 7, in a further embodiment, each of the claws 240 has one or more deflection gussets 420. Deflection gussets 420 are wedges that are attached to either side 422, 424 of each of the claws 240. The wedges are widest towards the bottoms 122 of the towers 118, and taper towards the tops 120 of the towers 118. In one embodiment, two gussets 420 are attached to each claw 240, one on one side 422 and one on the other side 424. The spindle 414 has four retainers 426, two on each end 416. One of the two retainers 426 on each end 416 of the spindle 414 engages the gusset 420 on the first side 422 of each arm 22. The other of the two retainers 426 on each end 416 of the spindle 414 engages the gusset 420 on the second side 424 of each arm 212.

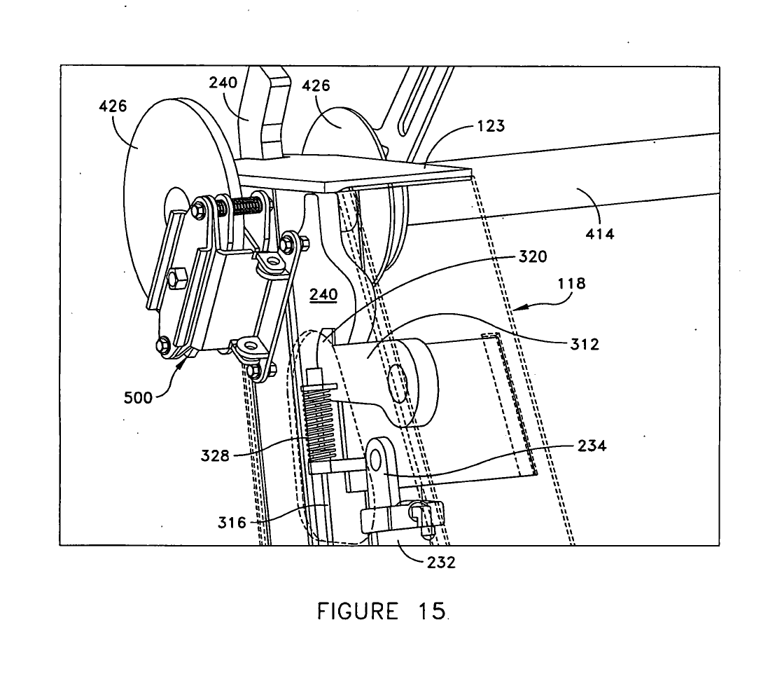

Referring to FIG. 15, in a further embodiment, an overspin brake 500 is attached to one or both of the towers 118. The overspin brake 500 controls the rotation of the spindle 414. The overspin brake 500 can be any kind of overspin break known in the art that is strong enough and durable enough to resist the rotational momentum of a fully loaded cable reel assembly 400. The overspin brake 500 can be configured to slow the rotation of the spindle 414, or to permit rotation of the spindle 414 in only one direction.

Referring to FIGS. 8-14, in a further embodiment, the base includes one or more jacks 600. A jack 600 can be attached to one of the towers 118, tow beams 132 or one of the pieces of the frame 110. The jack 600 can be any kind of jack known in the art that is strong enough to support the portion of the weight of the fully loaded cable reel that rests on the jack 600. Where a jack 600 is attached to the frame 110 or towers 118 near the wheels 140, the jack 600 can help prevent translational movement of the trailer 2 by creating friction against the ground. When a jack 600 is attached to the distal end of the base 100, the jack 600 supports the distal end of the base 100, when the trailer 2 is not coupled to a vehicle, and can maintain the frame 110 in a generally horizontal position. In an embodiment where the trailer 2 has only two wheels 140 (or two sets of adjacent wheels) the jack 600 and the wheels 140 provide at least three points of contact with the ground, stabilizing the trailer 2.

In one embodiment, the cylinders 232 are powered by a 12 volt battery-operated hydraulic unit, and are electronically controlled. A user can raise and lower the cantilevers 212 by a remote control action, such as pushing a button. In another embodiment, the cylinders 232 are powered by a user's action, such as manually pumping a hand pump.

An advantage of the disclosed device is that it does not require pins to secure the reel to the trailer, thus avoiding the difficulties and dangers associated with the use of pins in known devices. Another advantage of the device it that it is lightweight and has fewer large moving parts than known devices, making it durable and easy to use and transport. Yet another advantage is that the device lifts reels quickly and efficiently and secures reels for transport with minimal human assistance.

Although the invention has been described in terms of cable reels, it is not limited thereto. The invention can be constructed to any scale, and can be used to store and transport spools and reels of any kind of elongated material, such as fibers, ropes, cords, wires, and hoses of any size, weight, gauge, and material.

1-18. (canceled)

19. A cable reel trailer comprising
a base,
a pair of substantially parallel beams, each pinned at one end to the base;
at least one rotating member that engages the pair of substantially parallel beams; and
a latch assembly connected to the base and arranged so as to simultaneously engage or disengage the pair of substantially parallel beams through a full rotation of the rotating member.

20. The trailer of claim 1 wherein the latch assembly engages the pair of beams to secure the pair of beams in at least a fixed position with respect to the base.

21. The trailer of claim 1 wherein the base comprises
a frame comprising two substantially parallel beams connected by at least one substantially perpendicular crossbeam,
two towers extending outwardly from the frame,
two wheels wherein each wheel is connected to one of the frame and the towers,
one or more tow beams connected to the frame, and
a coupling connected to at least one of the one or more the tow beams.

22. The trailer of claim 1 wherein the beams are operatively connected by one or more crosspieces so as to achieve said simultaneous engaging or disengaging.

23. The trailer of claim 1 further including at least one tensioning member connected to the rotating member, wherein the tensioning member engages the pair of substantially parallel beams during compression of the tensioning member and disengages the pair of substantially parallel beams during expansion of the tensioning member.

24. The trailer of claim 5 further including at least one hydraulic cylinder connected to the pair of substantially parallel beams, wherein the at least one hydraulic cylinder provides power to the beams to pivot about the base.

25. The trailer of claim 1 wherein the beams include a pair of deflection gussets.

26. The trailer of claim 3 wherein the latch assembly comprises
two pegs connected to one of each of the two towers,
two latches, wherein each latch is rotatably connected to one of each of the two pegs,
two cords each having first and second ends wherein the first end of each cord is connected to one of each of the two latches,
two guides connected to the frame wherein one of each cord bends around one of each of the two guides,
a handle pivotally connected to the base wherein the handle is also connected to the second ends of the two cords.

27. The trailer of claim 1 wherein the beams lift a spindle that passes through a reel by pivoting with respect to the base.

28. The trailer of claim 10 wherein the latch assembly secures the beams in a fixed position with respect to the base, and whereby the latch assembly transfers at least a portion of the weight of the reel from the beams to the base.

29. The trailer of claim 3 wherein the trailer is transported by a vehicle coupled to the coupling.

30. The trailer of claim 1 wherein an over spin brake is attached to at least one of the towers.

31. A method of using the trailer of claim 1, the method comprising pivoting the beams with respect to the base.

32. A method of using a cable reel trailer, the method comprising
inserting a spindle through a reel,
moving a pair of beams with respect to a base, and
engaging the pair of beams simultaneously with a latch assembly connected to the base.

33. A method of using the trailer of claim 8, the method comprising
inserting a spindle through a reel,
positioning the trailer so that the towers are on either side of the reel,
pivoting the beams with respect to the base,
engaging the beams with the latch assembly,
pivoting the handle, and
rotating the latches.

34. A cable reel trailer comprising
a base having a pair of substantially parallel beams pivotally connected to said base, at least one rotating member connected to the pair of substantially parallel beams, and a latch assembly connected to said base and arranged so as to simultaneously engage or disengage the pair of substantially parallel beams through a rotation of the at least one rotating member, wherein said latch assembly includes a hook including an overhang portion extending outwardly and distally from a proximal end of a beam portion for retaining said spindle as said trailer traverses an incline.

35. A cable reel trailer comprising
a base having a pair of substantially parallel lifting members pivotally connected to said base, a latch assembly and tensioning member connected to the base and arranged so as to simultaneously engage or disengage the at least one substantially parallel lifting members through the use of the tensioning member.

36. A cable reel trailer comprising
a base having a pair of substantially parallel beams pivotally connected to said base, at least one movable member connected to the pair of substantially parallel beams, and a latch assembly connected to said base and arranged so as to simultaneously engage or disengage the pair of substantially parallel beams through a motion of the at least one movable member.

37. The cable reel trailer of claim 19, wherein the tensioning member is a spring.

38. The method of claim 15, wherein the step of engaging includes the use of at least one tensioning member.

39. The cable reel trailer of claim 20, further comprising one or more towers connected to said base, wherein the one or more towers extends substantially perpendicularly from said base and engages a spindle.
